(19) United States
(12) Patent Application Publication
(10) Pub. No.: US 2013/0086055 A1
(43) Pub. Date: Apr. 4, 2013

(54) APPARATUS AND METHOD FOR SEARCHING WITH CONSIDERATION USER'S ACTION

(71) Applicant: Samsung Electronics Co., Ltd, Gyeonggi-do (KR)

(72) Inventors: Seung-Hyun Yoon, Gyeonggi-do (KR); Moon-Sang Lee, Gyeonggi-do (KR); Mon-Soo Koo, Seoul (KR); Ji-In Nam, Seoul (KR)

(73) Assignee: Samsung Electronics Co., Ltd, Gyeonggi-do (KR)

(21) Appl. No.: 13/631,353

(22) Filed: Sep. 28, 2012

(30) Foreign Application Priority Data
Sep. 30, 2011 (KR) 10-2011-0099807

(51) Int. Cl. G06F 17/30

(52) U.S. Cl. 707/726; 707/723; 707/E17.014

(57) ABSTRACT

A method searches web objects. The method includes calculating a user rank for at least one web object based on a user's action and determining a listing order of at least one found web object using the user rank.

### CROSS-REFERENCE TO RELATED APPLICATION(S) AND CLAIM OF PRIORITY

The present application is related to and claims the benefit under 35 U.S.C. §119(a) to a Korean patent application filed in the Korean Intellectual Property Office on Sep. 30, 2011 and assigned Serial No. 10-2011-0099807, the entire disclosure of which is hereby incorporated by reference.

### TECHNICAL FIELD OF THE INVENTION

The present disclosure relates to a search system.

### BACKGROUND OF THE INVENTION

With the exponential growth in the number of pieces and types of data existing on a web, it becomes more important for a search engine to have a role capable of providing information required by a user in a prompt and accurate manner. Google® is a widely used search engine that provides a search service using an algorithm called a page rank. However, with the evolution of the web, the user generates/consumes data in various forms different from the conventionally used form, and as a result, there are many cases where the page rank algorithm fails to provide an optimal result. The reason above it that a user's action carried out on a web page cannot be taken into consideration because the page rank algorithm is based on an analysis of a link connected to the web page.

Accordingly, there is a need to provide an alternative method for providing a more convenient and effective service by considering a user's action to be carried out for a web page, data, contents, etc.

### SUMMARY OF THE INVENTION

To address the above-discussed deficiencies of the prior art, it is a primary aspect of the present invention to provide an apparatus and method for performing searching by considering a user's action.

Another aspect of the present disclosure is to provide an apparatus and method for calculating a rank by considering a user's action.

Another aspect of the present disclosure is to provide an apparatus and method for providing a search service by utilizing a social graph.

In accordance with an aspect of the present disclosure, a method for searching web objects is provided. The method includes calculating a user rank for at least one web object on the basis of a user's action, and determining a listing order of at least one found web object using the user rank.

In accordance with another aspect of the present disclosure, a method of operating a user device is provided. The method includes determining whether a user's action corresponding to a virtual in-link is generated, generating virtual in-link information for reporting the user's action, and transmitting the virtual in-link information.

In accordance with another aspect of the present disclosure, an apparatus for searching web objects is provided. The apparatus includes a storage unit for storing virtual in-link information for indicating a user's action, and a control unit for calculating a user rank for at least one web object on the basis of the user's action and for determining a listing order of at least one found web object using the user rank.

In accordance with another aspect of the present disclosure, a user device is provided. The user device includes a control unit for determining whether a user's action corresponding to a virtual in-link is generated and for generating virtual in-link information for reporting the user's action, and a communication unit for transmitting the virtual in-link information.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates the concept of determining a rank according to an exemplary embodiment of the present disclosure;

FIGS. 2A and 2B illustrate an example of a user action belonging to a virtual in-link according to an exemplary embodiment of the present disclosure;

FIG. 3 illustrates a process of operating a user device according to an exemplary embodiment of the present disclosure;

FIG. 4 illustrates a process of operating a search device according to an exemplary embodiment of the present disclosure;

FIG. 5 illustrates a process of operating a search device according to another exemplary embodiment of the present disclosure;

FIG. 6 illustrates a block diagram of a user device according to an exemplary embodiment of the present disclosure; and

FIG. 7 illustrates a block diagram of a search device according to an exemplary embodiment of the present disclosure.

Throughout the drawings, like reference numerals will be understood to refer to like parts, components and structures.

### DETAILED DESCRIPTION OF THE INVENTION

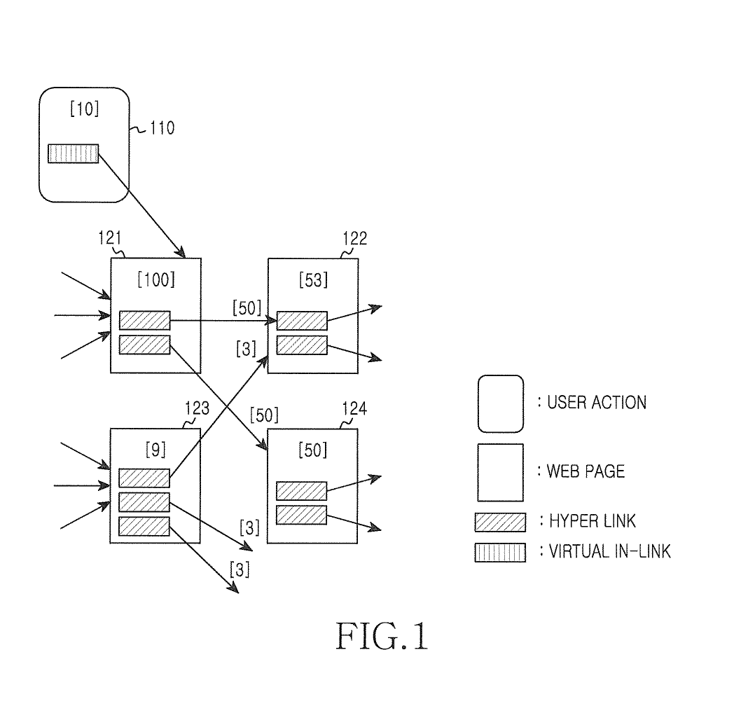

FIGS. 1 through 7, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged wireless communications system.

The present disclosure relates to an apparatus and method for performing searching by considering a user's action in the search system. Hereinafter, a technique for performing searching by considering a user's action in a search system will be described. In the following description, a user device includes a cellular phone, a Personal Communication System (PCS), a Personal Digital Assistant (PDA), an International Mobile Telecommunication-2000 (IMT-2000) terminal, a smart phone, a table Personal Computer (PC), a lap-top computer, a desk-top computer, etc.

According to the present disclosure, the user device recognizes a user's action for a specific web object, and provides the recognition result to a device for performing searching. As a result, the device for performing searching determines a rank according to data provided from the user device and a Uniform Resource Locator (URL) page analysis result, and provides the search result. Hereinafter, for convenience of explanation, the device for performing searching is referred to as a search device. The search device includes a device that has information for determining a rank and that determines the rank using the information, a device that does not have the information for determining the rank but is capable of collecting the information, and a device that determines the rank using the collected information. Therefore, if the user device can collect the information for determining the rank, the user device can also be used as the search device.

FIG. 1 illustrates the concept of determining a rank according to an exemplary embodiment of the present disclosure. In FIG. 1, ranks of web pages 121 to 124 are determined using one user action 110 and the four web pages 121 to 124.

Referring to FIG. 1, the 1st web page 121 has a rank of 100, and includes two hyperlinks. Accordingly, each of the two links from the 1st web page 121 has a weight of 50. The two links each having the weight of 50 are respectively directed to the 2nd web page 122 and the 4th web page 124. Therefore, the weight of 50 is assigned from the 1st web page 121 to each of the 2nd web page 122 and the 4th web page 124. The two links are outgoing links from the perspective of the 1st web page 121, and are incoming links from the perspective of the 2nd web page 122 and the 4th web page 124. In addition, the 3rd web page 123 has a rank of 9, and includes three hyperlinks. Accordingly, each of the three links from the 3rd web page 123 has a weight of 3. One of the three links each having the weight of 3 is directed to the 2nd web page 122. The weight of 3 is assigned from the 3rd page 123 to the 2nd page 122. As a result, the 2nd web page 122 has a weight of 53, and the 4th web page has a weight of 50. A rank based on the hyperlink can be referred to as a page rank.

In addition thereto, according to the exemplary embodiment of the present disclosure, a weight based on the user action 110 is further assigned. The user action 110 represents a user's interest on the 1st web page 121. A rank based on the user action 110 can be referred to as a user rank. As illustrated in FIG. 1, the user action 110 has a weight of 10, and includes one virtual in-link. The virtual in-link is generated for the 1st web page 121. That is, a page rank for the 1st web page 121 is 100, and a user rank thereof is 10. A final rank is determined by combining the page rank and the user rank. The final rank can be determined by simple adding the page rank and the user rank or by adding the ranks with assigned weights. For example, the final rank can be determined by Equation (1) below.

$$Rank ( u ) = ( 1 - d ) + d {\sum }_{v ∈ B ( u )} \frac{PageRank ( v )}{{N}_{v}} + {\sum }_{v ∈ K ( u )} UserRank ( v ) \qquad ( 1 )$$

In Equation (1) above, Rank(u) denotes a final rank for a web page u, d denotes an attenuation constant, B(u) denotes an index set of a web page having an incoming link of the web page u, PageRank(v) denotes a page rank for a web page v, Nv denotes the number of outgoing links of the web page v, K(u) denotes an index set of a virtual in-link generated for the web page u, and UserRank(v) denotes a user rank for a virtual in-link v.

The user action 110 considered in the user rank can be defined differently according to a detail embodiment of the present disclosure. Although only one user action 110 is illustrated in FIG. 1, a plurality of user actions can be defined. Further, weights assigned to the respective user actions may be different from one another. A criterion for defining a magnitude relation of the weights may vary depending on the detailed embodiment of the present disclosure. For example, an action that can declare an intention only one time per user with respect to a specific web object may have a weight greater than that of an action that can be repetitively carried out. In addition, regarding a user's intentional action for increasing a rank, it is possible to apply a criterion capable of preventing a rank for a specific web object from being unreasonably distorted by decreasing a weight.

Examples of the user actions may include an action for scrapping a URL of a web object, an action for re-processing the web object in a summarized form, an action for voting for the web object, an action for posting a comment/reply, and an action for consuming web object information for a long time period. The action for voting includes an action for clicking ‘like’ in the Facebook, i.e., a well-known Social Network Service (SNS). The action for re-processing the web object in a summarized form is an action for processing contents and related information as one data chunk according to a user's request and can be referred to as ‘clip’. The action for consuming the web object information for a long time period is determined simply according to a time criterion, and also includes consuming of a web object for a long time period consumed in accordance with a mouse scroll or the like. Therefore, a rank for a web object in which a user action such as the clip is performed by many users is increased, and the web object can be arranged with higher ranking in a search result.

In the aforementioned exemplary embodiment, a final rank for the web page is determined by combining a page rank and a user rank. However, according to another exemplary embodiment of the present disclosure, a search device can determine the final rank using only the user rank. Information on the user action is transmitted by the user device to the search device and thus is collected in the search device. However, if the information is stored inside the user device instead of being transmitted by the user device and the information can be accessed by another device in a Uniform Resource Identifier (URI) form, the information can be utilized as a user action belonging to the virtual in-link.

A scope of considering the user action is not particularly limited in the aforementioned exemplary embodiment. However, according to another exemplary embodiment of the present disclosure, when a search service is provided to a specific user, the search device can limit the scope of the user action to be considered. For example, if the search device can acquire social graph information of the specific user, the search device can consider only a user action carried out by another user on the social graph of the specific user. The social graph implies information that summarizes a request of users or a connection relation between users and generated by a request/acceptance. For example, the connection relation implies a friend in Facebook®, a follower on Twitter®, etc.

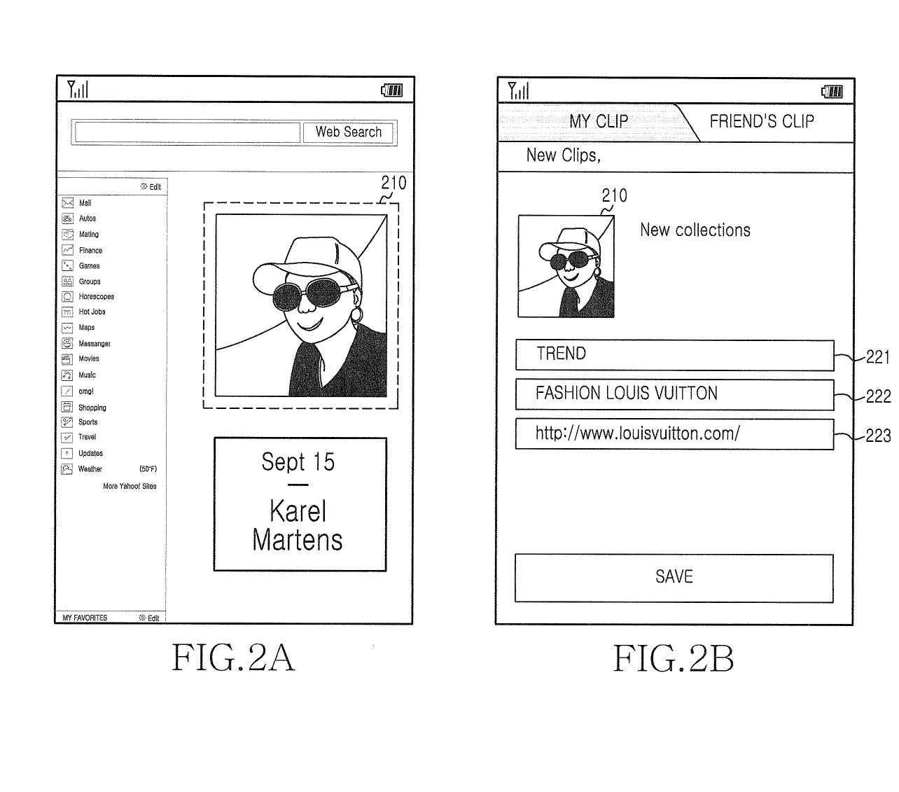

FIGS. 2A-B illustrate an example of a user action belonging to a virtual in-link according to an exemplary embodiment of the present disclosure. A clip is illustrated in FIGS. 2A-B as one of user actions considered in a user rank.

FIG. 2A illustrates a web page. A user can browse a specific web page as illustrated in FIG. 2A by executing a web browser of a user device. In this case, the user intends to store a photo 210 included in the web page and information related thereto. The user can designate an area for displaying the photo 210 using the clip function, and can store the related information. More specifically, the user activates the clip function, and determines a region of interest to be stored.

FIG. 2B illustrates a storing result. As illustrated in FIG. 2B, stored contents, i.e., a photo 210 and related information items 221 to 223 are included in clip data. For example, the related information items 221 to 223 can be stored in an eXtensible Markup Language (XML) file format. Herein, some or all of the related information items 221 to 223 can be extracted according to an input of a user or can be extracted automatically without an intervention of the user. Although an example of clipping only a part of the web page is illustrated in FIG. 2, clipping of the entirety of the web page is also possible.

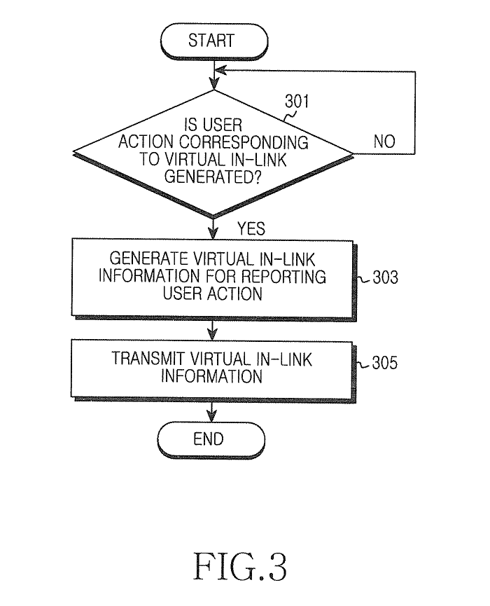

FIG. 3 illustrates a process of operating a user device according to an exemplary embodiment of the present disclosure.

Referring to FIG. 3, the user device determines whether a user action corresponding to a virtual in-link is generated in step 301. In other words, the user device determines whether a user action considered in a user rank is generated. For example, the user action considered in the user rank can include at least one of an action for scrapping a URL of a web object, an action for re-processing the web object in a summarized form, an action for voting for the web object, and an action for posting a comment/reply.

If the user action considered in the user rank is generated, proceeding, to step 303, the user device generates virtual in-link information for reporting the user action. The virtual in-link information can include at least one of a user action type, a generation target, and a generation time. In this case, according to another embodiment of the present disclosure, if a user action corresponding to a condition defined by a determination of the user is generated, the user device may not generate the virtual in-link information. For example, if the user determines not to transmit the virtual in-link information with respect to a specific URL, the user device does not generate the virtual in-link information for the specific URL. Alternatively, the user device may generate the virtual in-link information for the specific URL but may not transmit the generated information.

In step 305, the user device transmits the virtual in-link information to the search device. In this case, according to the exemplary embodiment of the present disclosure, the user device can transmit the virtual in-link information immediately after the user action is generated. According to another exemplary embodiment of the present disclosure, the user device can transmit at least one piece of virtual in-link information accumulated for one period with a specific time interval according to a pre-defined period. According to still another exemplary embodiment of the present disclosure, a time for transmitting the virtual in-link information can be determined according to a criterion different from the aforementioned criterion.

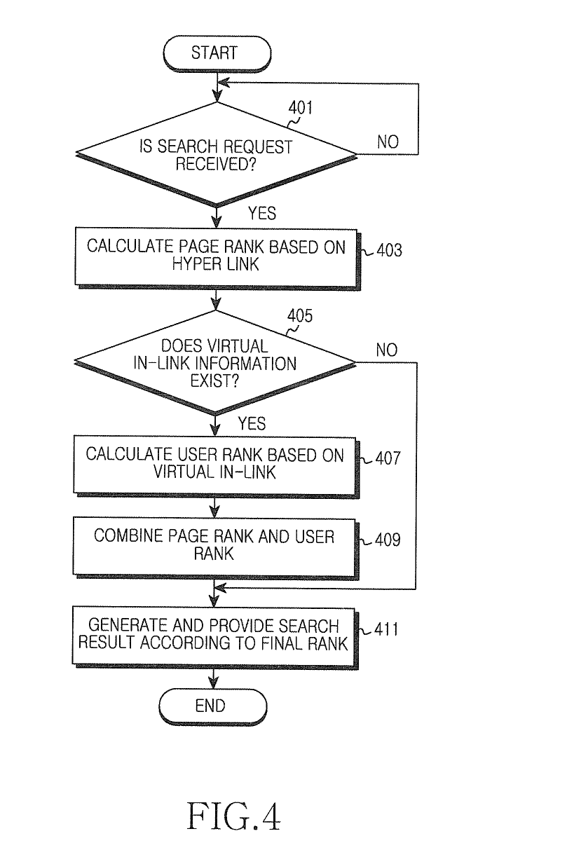

FIG. 4 illustrates a process of operating a search device according to an exemplary embodiment of the present disclosure.

Referring to FIG. 4, the search device determines whether a search request is received in step 401. The search request is received from the user device. However, if the search device is the user device, the search request may be generated inside the user device according to a user's manipulation. For example, the search request may include a search keyword.

Upon receiving, the search request, proceeding to step 403, the search device calculates a page rank based on a hyperlink. More specifically, the search device confirms a page rank for a different web page including an incoming link of a specific web page and the number of links, and assigns a weight obtained by dividing the rank for the different web page by the number of links to the specific web page. Although it is illustrated in FIG. 4 that the step 403 is performed when receiving the search request, according to another exemplary embodiment of the present disclosure, the step 403 can be performed as a separate process irrespective of the search request reception. For example, the step 403 can be performed upon detection of generation, update, and deletion of the web page, or can be performed periodically according to a pre-defined time interval.

In step 405, the search device determines whether the virtual in-link information exists. The virtual in-link information is generated depending on a user's action, and is provided from the user device to the search device. That is, the search device stores the virtual in-link information received from the user device. If the virtual in-link information does not exist, the search device determines the page rank as a final rank, and the procedure proceeds to step 411.

Otherwise, if the virtual in-link information exists, proceeding to step 407, the search device calculates a user rank based on a virtual in-link. More specifically, the search device confirms a user action type of the virtual in-link, confirms a weight assigned to the confirmed type, and then assigns a weight corresponding to the number of virtual in-links to a web page.

After calculating the user rank, proceeding to step 409, the search device determines a final rank by combining the page rank and the user rank. For example, the search device adds the page rank and the user rank. In this case, weights of the page rank and the user rank can be differently determined in the present disclosure so that the two ranks are considered with different importance. In this case, the search device multiplies the page rank and the user rank by the respective weights, and then adds the resultant ranks. For example, the search device can determine the final rank according to Equation (1) above.

After combining the page rank and the user rank, proceeding to step 411, the search device generates a search result according to the final rank, and transmits the search result to a user device which transmits the search request. That is, the search device searches for at least one web object related to a keyword included in the search request, and thereafter determines a listing order of the at least one found web object using the final rank.

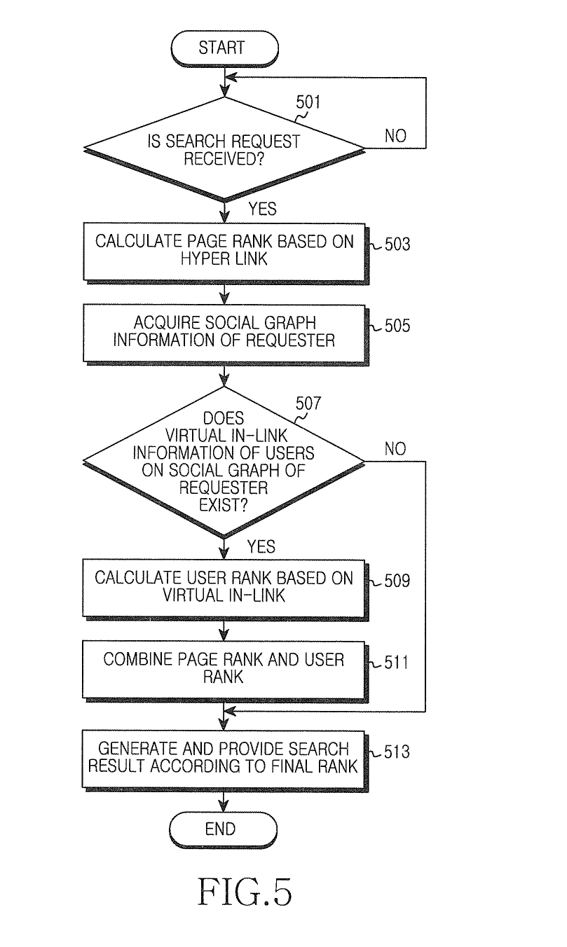

FIG. 5 illustrates a process of operating a search device according to another exemplary embodiment of the present disclosure.

Referring to FIG. 5, the search device determines whether a search request is received in step 501. The search request is received from a user device. However, if the search device is the user device, the search request may be generated inside the user device according to a user's manipulation. For example, the search request may include a search keyword.

Upon receiving the search request, proceeding to step 503, the search device calculates a page rank based on a hyperlink. More specifically, the search device confirms a page rank for a different web page including an incoming link of a specific web page and the number of links, and assigns a weight obtained by dividing the rank for the different web page by the number of links to the specific web page. Although it is illustrated in FIG. 5 that the step 503 is performed when receiving the search request, according to another exemplary embodiment of the present disclosure, the step 503 can be performed as a separate process irrespective of the search request reception. For example, the step 503 can be performed upon detection of generation, update, and deletion of the web page, or can be performed periodically according to a pre-defined time interval.

In step 505, the search device acquires social graph information of a requester which transmits the search request. According to the exemplary embodiment of the present disclosure, the social graph information may be stored in the search device. For one example, if the search device provides an SNS service in addition to the search service, the search device can store the social graph information. In this case, the search device confirms identification information (e.g., SNS IDentifier (ID)) of the requester, and reads corresponding social graph information. For another example, if the search device is the user device, the search device can store social graph information of a corresponding user. According to another exemplary embodiment of the present disclosure, the social graph information is stored in a different device, and the search device can receive the social graph information provided from the different device. In this case, the search device requests the different device to send the social graph information of the request, and receives the social graph information.

After acquiring the social graph information, proceeding to step 507, the search device determines whether there is virtual in-link information of at least one user on the social graph of the requester. Herein, the at least one user of the social graph of the requester includes the requester, and may further include at least one different user having a connection relation with the requester. The virtual in-link information is generated depending on a user's action, and is provided from the user device to the search device. That is, the virtual in-link information received from the user device is stored in the search device. If the virtual in-link information does not exist, the search device determines the page rank as a final rank, and the procedure proceeds to step 513.

Otherwise, if the virtual in-link information exists, proceeding to step 509, the search device calculates a user rank based on a virtual in-link of at least one user on a social graph of the requester. More specifically, the search device extracts a virtual in-link of at least one user on the social graph of the requester among all virtual in-links, confirms a user action type of the extracted virtual in-link, confirms a weight assigned to the confirmed type, and then assigns a weight corresponding to the number of virtual in-links to a web page.

After calculating the user rank, proceeding to step 511, the search device determines a final rank by combining the page rank and the user rank. For example, the search device adds the page rank and the user rank. In this case, weights of the page rank and the user rank can be differently determined in the present disclosure so that the two ranks are considered with different importance. In this case, the search device multiplies the page rank and the user rank by the respective weights, and then adds the resultant ranks. For example, the search device can determine the final rank according to Equation (1) above.

After combining the page rank and the user rank, proceeding to step 513, the search device generates a search result according to the final rank, and transmits the search result to a user device which transmits the search request. That is, the search device searches for at least one web object related to a keyword included in the search request, and thereafter determines a listing order of the at least one found web object using the final rank.

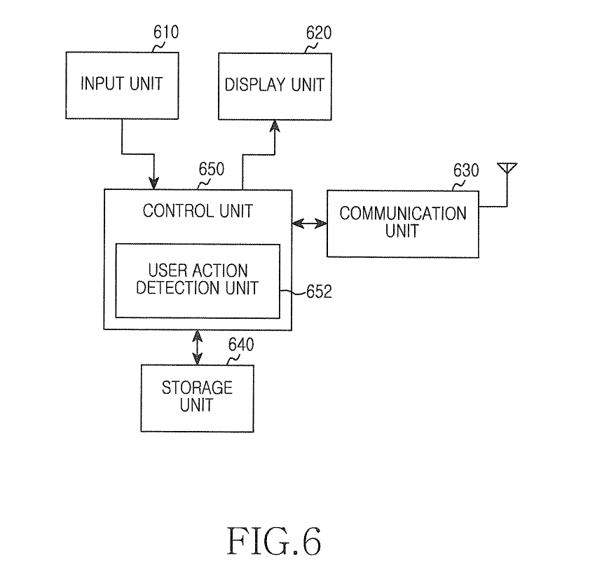

FIG. 6 illustrates a block diagram of a user device according to an exemplary embodiment of the present disclosure.

Referring to FIG. 6, the user device includes an input unit 610, a display unit 620, a communication unit 630, a storage unit 640, and a control unit 650.

The input unit 610 recognizes an input generated by a user, and provides information corresponding to the input to the control unit 650. That is, the input unit 610 processes a user input through a keyboard, a keypad, a touch screen, a touch pad, a mouse, a special function button, etc. The display unit 620 displays status information, which is generated while the terminal operates, and alphanumeric characters, images, etc., produced while an application program is executed. That is, the display unit 620 displays image data provided from the control unit 650 on a visual screen. For example, the display unit 620 may be a Liquid Crystal Display (LCD), an Organic Light-Emitting, Diode (OLED), etc.

The communication unit 630 provides an interface for signal transmission and reception through a wireless channel. That is, the communication unit 630 transmits Transmit (Tx) data by converting the data into a Radio Frequency (RF) signal, and converts the RF signal received through the antenna into Receive (Rx) data. In this case, the communication unit 630 performs conversion between the data and the RF signal according to a communication system protocol. Although the communication unit 630 is illustrated in FIG. 6 as a block which includes an antenna for wireless communication, the communication unit 630 may provide an interface for wired communication according to another exemplary embodiment of the present disclosure. In this case, the communication unit 630 includes a node capable of connecting a wired path.

The storage unit 640 stores a basic program for an operation of the user device, an application program, and data such as user contents. Further, the storage unit 640 provides stored data at the request of the control unit 650. For example, the storage unit 640 can store social graph information of a user of the user device. Further, the storage unit 640 can store virtual in-link information generated in the control unit 650. Furthermore, if the user device provides a search service, the storage unit 640 can store virtual in-link information of other users.

The control unit 650 provides overall control to the user device. According to the exemplary embodiment of the present disclosure, the control unit 650 includes a user action detection unit 652 for recognizing a user action belonging to a virtual in-link. The control unit 650 determines whether a user action considered to calculate the user rank is generated using the user action detection unit 652, generates virtual in-link information for reporting the user action, and transmits the virtual in-link information to the search device via the communication unit 630. The virtual in-link information may include at least one of a user action type, a generation target, and a generation time. In this case, according to another embodiment of the present disclosure, if a user action corresponding to a condition defined by a determination of the user is generated, the control unit 650 may not generate the virtual in-link information. In this case, the virtual in-link information may be transmitted immediately after being generated, or may be transmitted by being accumulated for one period with a specific time interval according to a pre-defined period, or may be transmitted at a time determined according to another criterion.

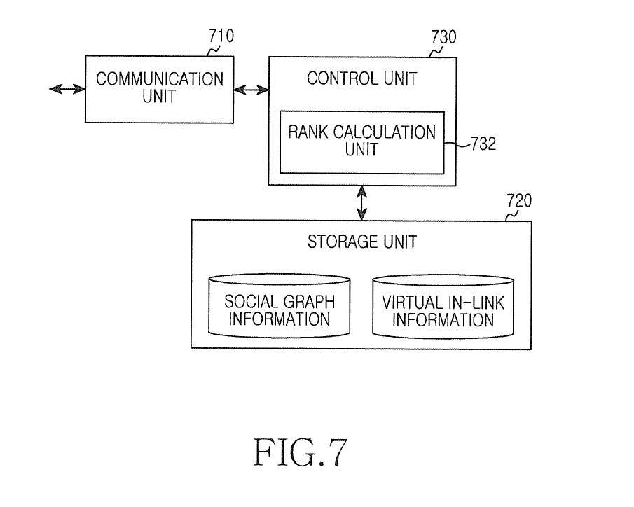

FIG. 7 illustrates a block diagram of a search device according to an exemplary embodiment of the present disclosure.

Referring to FIG. 7, the search device includes a communication unit 710, a storage unit 720, and a control unit 730.

The communication unit 710 provides an interface for communication. That is, the communication unit 710 transmits Tx data by converting the data into a physical signal, and converts a received physical signal into Rx data. In this case, the communication unit 710 performs conversion between data and a signal according to a protocol of a communication system. The storage unit 720 stores a basic program for an operation of the search device, an application program, and data such as configuration information. Further, the storage unit 720 provides stored data at the request of the control unit 730. For example, the storage unit 720 can store social graph information of users and virtual in-link information received from the users.

The control unit 730 controls overall functions of the search device. For example, the control unit 730 performs a search function. In this case, according to the exemplary embodiment of the present disclosure, the control unit 730 includes a rank calculation unit 732. The rank calculation unit 732 calculates a user rank using virtual in-link information stored in the storage unit 720, and determines a final rank using the user rank. An operation of the control unit 730 for the search function can be described below in detail.

The control unit 730 determines a final rank by combining a user rank and a page rank for each web object. In this case, the control unit 730 may calculate the page rank upon reception of a search request of a user via the communication unit 710 or may calculate the page rank upon detection of generation, update, and deletion of the web page or periodically according to a pre-defined time interval. If virtual in-link information does not exist, the calculation of the user rank is omitted, and the page rank is determined as the final rank. In the combining of the page rank and the user rank, the control unit 730 may add the page rank and the user rank or may add the ranks after multiplying the page rank and the user rank by respective weights. However, according to another exemplary embodiment of the present disclosure, the control unit 730 may determine the final rank using only the user rank while excluding the page rank. Thereafter, the control unit 730 searches for at least one web object related to a keyword included in the search request, and thereafter determines a listing order of the at least one found web object using the final rank.

According to another exemplary embodiment of the present disclosure, the control unit 730 can determine a rank by considering a social graph of a requester which transmits the search request. In this case, the control unit 730 acquires social graph information of the requester, and may consider only virtual in-link information of at least one user on a social graph of the requester in the calculation of the user rank. According to one exemplary embodiment of the present disclosure, the social graph information may be stored in the storage unit 720. In this case, the control unit 730 reads social graph information corresponding to the requester. According to another exemplary embodiment of the present disclosure, if the social graph information is stored in a different device, the control unit 730 requests the different device to send the social graph information of the requester via the communication unit 710, and receives the social graph information.

Although the search device of FIG. 7 has a structure different from that of the user device, the user device can provide a search service according to another exemplary embodiment of the present disclosure. In this case, a function of the control unit 730 can be performed by the control unit 650 of FIG. 6.

According to exemplary embodiments of the present disclosure, a search system can provide a search service in a more user friendly and more effective manner by considering user action information in a rank. In addition, since the user action information can belong to social information, it is possible to perform a social search.

What is claimed is:

1. A method for searching web objects, the method comprising:
calculating a user rank for at least one web object based on a user action; and
determining a listing order of at least one found web object using the user rank.

2. The method of claim 1, wherein calculating the user rank comprises:
confirming a type of the user action that occurred in a first web object;
confirming a weight corresponding to the confirmed type; and
assigning the weight based on a number of virtual in-links generated by the user action to the first web object.

3. The method of claim 1, wherein calculating the user rank comprises:
extracting at least one virtual in-link generated by at least one user action generated by at least one user on a social graph of a requester that requests a search; and
calculating the user rank for the at least one web object using the extracted at least one virtual in-link.

4. The method of claim 3 further comprising:
requesting a device having the social graph information to transmit social graph information of the requester; and
receiving the social graph information.

5. The method of claim 1, wherein determining the listing order of the at least one found web object using the user rank comprises:
determining the user rank as a final rank; and
determining the listing order according to the final rank.

6. The method of claim 1 further comprising
calculating a page rank for the at least one web object based on a hyperlink included in the at least one web object,
wherein determining the listing order of the at least one found web object using the user rank comprises:
determining a final rank by combining the user rank and the page rank; and
determining the listing order according to the final rank.

7. The method of claim 1 further comprising:
receiving virtual in-link information for reporting the user action from a user device.

8. The method of claim 1 further comprising:
transmitting a search result to a user device that requests a search.

9. The method of claim 1 further comprising:
displaying the search result using a display unit.

10. A method of operating a user device, the method comprising:
determining whether a user action corresponding to a virtual in-link occurs;
generating virtual in-link information for reporting the user action; and
transmitting the virtual in-link information.

11. The method of claim 10, wherein the user action includes at least one of an action for scrapping a Uniform Resource Locator (URL) of a web object, an action for re-processing the web object in a summarized form, an action for voting for the web object, and an action for posting a comment/reply.

12. The method of claim 10, wherein transmitting the virtual in-link information comprises:
transmitting the virtual in-link information after the user action is generated.

13. The method of claim 10, wherein transmitting the virtual in-link information comprises:
transmitting at least one piece of virtual in-link information accumulated for one period with a specific time interval according to a pre-defined period.

14. An apparatus configured to search web objects, the apparatus comprising:
a storage unit configured to store virtual in-link information for indicating a user action; and
a control unit configured to calculate a user rank for at least one web object based on the user action and determine a listing order of at least one found web object using the user rank.

15. The apparatus of claim 14, wherein to calculate the user rank, the control unit is further configured to confirm a type of the user action that occurred in a first web object, confirm a weight corresponding to the confirmed type, and assign the weight based on a number of virtual in-links generated by the user action to the first web object.

16. The apparatus of claim 14, wherein the controller is further configured to extract at least one virtual in-link generated by at least one user action generated by at least one user on a social graph of a requester that requests a search, and calculate the user rank for the at least one web object using the extracted at least one virtual in-link.

17. The apparatus of claim 16, wherein the controller is further configured to request a device having the social graph information to transmit social graph information of the requester, and receive the social graph information.

18. The apparatus of claim 14, wherein to determine the listing order of the at least one web object, the controller is further configured to determine the user rank as a final rank, and determine the listing order according to the final rank.

19. The apparatus of claim 14, wherein to determine the listing order of the at least one web object, the controller is further configured to calculate a page rank for the at least one web object based on a hyperlink included in the at least one web object, determine a final rank by combining the user rank and the page rank and determine the listing order according to the final rank.

20. The apparatus of claim 14 further comprising:
a communication unit configured to receive virtual in-link information for reporting the user action from a user device.

21. The apparatus of claim 14 further comprising:
a communication unit configured to transmit a search result to a user device that requests a search.

22. The apparatus of claim 14 further comprising:
a display unit configured to display the search result.

23. A user device comprising:
a control unit configured to determine whether a user action corresponding to a virtual in-link is generated and generate virtual in-link information for reporting the user action; and
a communication unit configured to transmit the virtual in-link information.

24. The apparatus of claim 23, wherein the user action includes at least one of an action for scrapping a URL of a web object, an action for re-processing the web object in a summarized form, an action for voting for the web object, and an action for posting a comment/reply.

25. The apparatus of claim 23, wherein the control unit is further configured to provide control to transmit the virtual in-link information after the user action is generated.

26. The apparatus of claim 23, wherein the controller provide is further configured to control to transmit at least one piece of virtual in-link information accumulated for one period with a specific time interval according to a pre-defined period.
